(19) United States
(12) Patent Application Publication
(10) Pub. No.: US 2002/0085645 A1
(43) Pub. Date: Jul. 4, 2002

(54) Bi-directional wireless communication

(75) Inventors: Zion Hadad, Rishon Lezion (IL); Yossef Barak, Rishon Lezion (IL)

Correspondence Address: BROWDY AND NEIMARK, P.L.L.C., 624 NINTH STREET, NW, SUITE 300, WASHINGTON, DC, 20001-5303, US

(73) Assignee: INNOWAVE ECI WIRELESS SYSTEMS LTD., Petach Tikva (IL)

(21) Appl. No.: 09/950,811

(22) Filed: Sep. 13, 2001

(30) Foreign Application Priority Data
Sep. 13, 2000 (IL) 138454

(51) Int. Cl. H04B 15/00

(52) U.S. Cl. 375/285; 714/755

(57) ABSTRACT

A Bi-directional wireless telecommunication system includes a pair of transceivers each including a transmitter having a transmit delay D_{T}, and a receiver having a receive delay D_{R} wherein compacted concatenated FEC coding is achieved, and having an overall one-way transmission delay including a transmit delay D_{T} and a receive delay D_{R} of less than about 10 ms.

### FIELD OF THE INVENTION

The invention is in the field of bi-directional wireless telecommunication systems, and a transmitter therefor and a receiver therefor.

### BACKGROUND OF THE INVENTION

Broadband wireless LAN communication is supported for single cell mobile Local Area Networks (LANs) in accordance with the HIgh PErformance Radio Local Area Network type 2 (HIPERLAN/2) and IEEE 802.11a Technical Specifications (TSs), hereby incorporated by reference. These TSs stipulate convolutional Forward Error Correction (FEC) coding for handling the more prevalent errors in mainly indoor single cell environments, namely, random type errors as opposed to burst type errors. By virtue of the intended mobile environments, these TSs can afford a relatively high 10⁻⁶ Bit Error Rate (BER) for an about 5 dB E_{b}/Nₒ (Energy per bit /Noise spectral density) in comparison to an 10⁻¹¹ BER industry standard for data applications. Moreover, since the LANs support mainly data applications, these TSs can also afford relatively long one-way delays in comparison to telephony industry standards of less than or equal to 10 ms.

Digital Video Broadcasting (DVB) in accordance with the DAVIC standard stipulates a cascaded concatenation arrangement for affording an 10⁻¹¹ BER, and a relatively short 10 ms to 15 ms delay in each of a transmitter and a receiver by virtue of a high 10 Mbps to 40 Mbps raw data transfer rate. The cascaded concatenation arrangement includes an outer Reed Solomon (RS) stage for handling burst type errors, an about 12 kbit deep interleaver, and an inner convolutional code stage for handling random type errors.

### SUMMARY OF THE INVENTION

In accordance with a first aspect of the present invention, there is provided a bi-directional wireless telecommunication system comprising a pair of transceivers each including a transmitter having a transmit delay D_{T}, and a receiver having a receive delay D_{R};

characterized in:

the telecommunication system implementing compacted concatenated FEC coding, and having an overall one-way transmission delay including a transmit delay D_{T} and a receive delay D_{R} of less than about 10 ms.

The present invention is based on the realization that concatenation FEC coding hitherto employed for DVB applications can be modified for bi-directional wireless communication to afford relatively low BERs with relatively short round one-way transmission delays consistent with toll quality telephony industry standards. This is achieved by processing smaller data blocks than those in DVB applications, say, preferably of less than 200 bits, and of an exemplary 96 bits at a 64 kbps raw data transfer rate, thereby negating the need for an interleaver as deployed in the conventional cascaded concatenation arrangement, and whose absence is reflected in the coined term “compacted concatenation FEC coding”. However, compacted concatenated FEC coding is more susceptible to burst like errors arising from pulse jamming, inter cell interference in a multi-cell environment, and the like, which can be at least partially mitigated by nullification of corrupt data symbols identifiable by their receiving power value falling outside a so-called error free power zone. Compacted concatenation FEC coding together with corrupt wireless data symbol nullification can achieve between ˜10⁻⁶ to ˜10⁻⁷ BER for relatively low ˜4 dB E_{b}/Nₒ values up from ˜10⁻⁵ BER without nullification, and ˜10⁻⁸ BER for higher ˜7 dB E_{b}/Nₒ values up from ˜10⁻⁶ to ˜10⁻⁷ BER without nullification. Thus, a bi-directional wireless telecommunication system in accordance with the present invention can be suitably implemented for both Point-to-Point architectures, and more demanding Point-to-MultiPoint (PMP) architectures in terms of E_{b}/Nₒ requirements.

In accordance with a second aspect of the present invention, there is provided a method for identifying a corrupt wireless data symbol, the method comprising the steps of:

(One) determining an error free power zone for an m-dimension I/Q signal constellation where m=2^{k} and k=1, 2, . . . , n;

(Two) reconstructing the I/Q signal constellation of an incoming modulated data symbol; and

(Three) identifying a data symbol as corrupt in the event that its receiving power falls outside the power zone.

### BRIEF DESCRIPTION OF THE DRAWINGS

In order to understand the present invention and to see how it is carried out in practice, preferred embodiments will now be described, by way of non-limiting examples only, with reference to the accompanying drawings in which similar parts are likewise numbered, and in which:

FIG. 1 is a schematic diagram of a bi-directional wireless telecommunication system constructed and operative in accordance with the present invention;

FIG. 2 is a block diagram of a transmitter and a receiver of a station of the system of FIG. 1;

FIG. 3 is a flow diagram of a method for identifying a corrupt wireless data symbol; and

FIGS. 4 and 5 shows two error free power zones on an 8 point I/Q signal constellation for use in the method of FIG. 3.

### DETAILED DESCRIPTION OF THE DRAWINGS

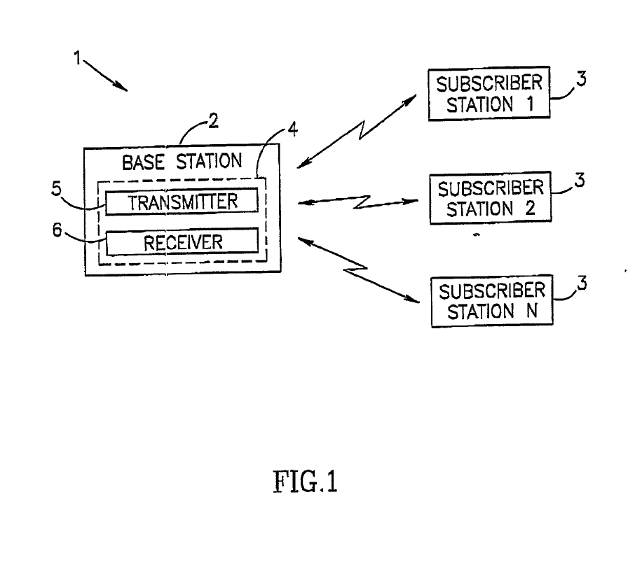

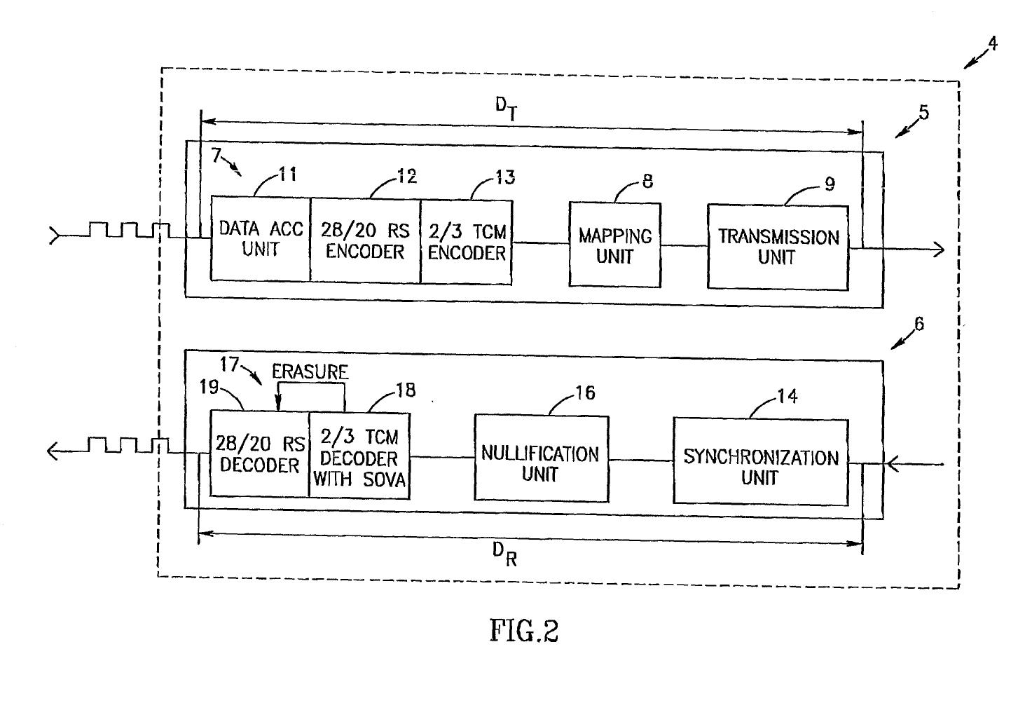

FIG. 1 shows a multi-code CDMA based fixed access bi-directional wireless telecommunication system 1 including a base station 2, and a multitude of subscriber stations 3. The base station 2 and each subscriber station 3 each include a transceiver 4 including a transmitter 5 having a transmit delay D_{T} (see FIG. 2), and a receiver 6 having a receive delay D_{R} (see FIG. 2) whereby the telecommunication system 1 has an overall one-way transmission delay mainly consisting of a transmitter's transmit delay D_{T} and a receiver's receive delay D_{R} of about 10 ms.

FIG. 2 shows that each transmitter 5 includes a concatenation encoder 7 for encoding a 64 kbps stream of raw data into a concatenated encoded stream of data symbols, a mapping unit 8 for modulating the stream of concatenated encoded data symbols onto an 8PSK I/Q signal constellation, and a transmission unit 9 for transmitting the stream of modulated data symbols. The transmitter 5 has a maximum transmit delay D_{T} across the concatenation encoder 7, the mapping unit 8, and the transmission unit 9 of 5 ms.

The concatenation encoder 7 includes a data accumulation unit 11 for accumulating 96 bit data blocks from the stream of raw data, an outer 28/20 Reed Solomon (RS) encoder 12 for encoding the data blocks to provide a stream of encoded data symbols, and an inner ⅔ (4 to 8 PSK) Trellis Coding Modulation (TCM) encoder 13 for encoding the stream of encoded data symbols to provide the stream of concatenated encoded data symbols. The data acquisition unit 11 accumulates the 96 bit data blocks within about 1.5 ms whilst the remaining about 3.5 ms of the transmit delay D_{T} is divided between the remaining units 8 and 9.

FIG. 2 also shows that each receiver 6 includes a synchronization unit 14 for reconstructing the I/Q signal constellation of an incoming 8PSK modulated data symbol to provide a stream of concatenated encoded data symbols, a nullification unit 16 for selectively nullifying incoming data symbols whose receiving power falls outside an error free power zone defined for the 8PSK I/Q signal constellation, and a concatenation decoder 17 for decoding the concatenated encoded data symbols passed by the nullification unit 16 to provide a stream of data. The receiver 6 has a maximum receive delay D_{R} across the synchronization unit 14, the nullification unit 16, and the concatenation decoder 17 of 5 ms. The concatenation decoder 17 includes an inner ⅔ TCM decoder 18 with SOVA for decoding the stream of concatenated encoded data symbols to provide a stream of encoded data symbols, and an outer 28/20 RS decoder 19 for decoding the stream of encoded data symbols to provide a stream of data.

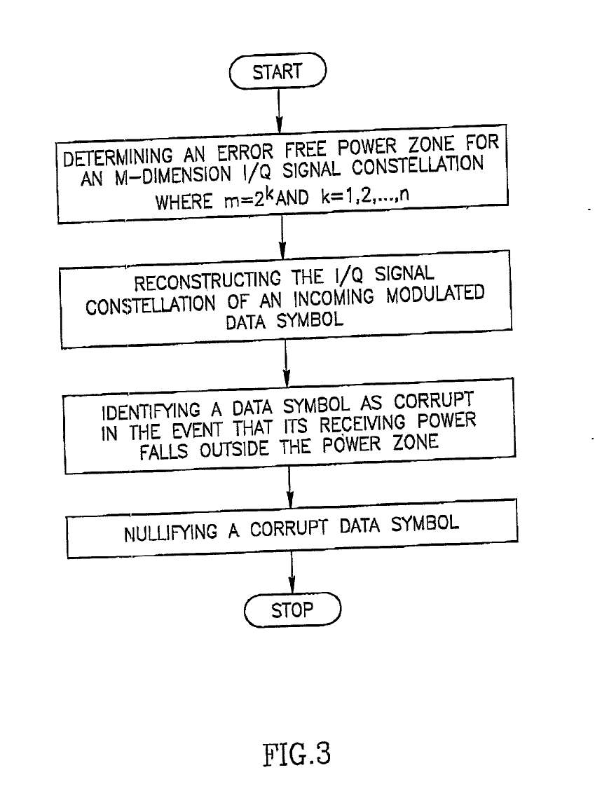

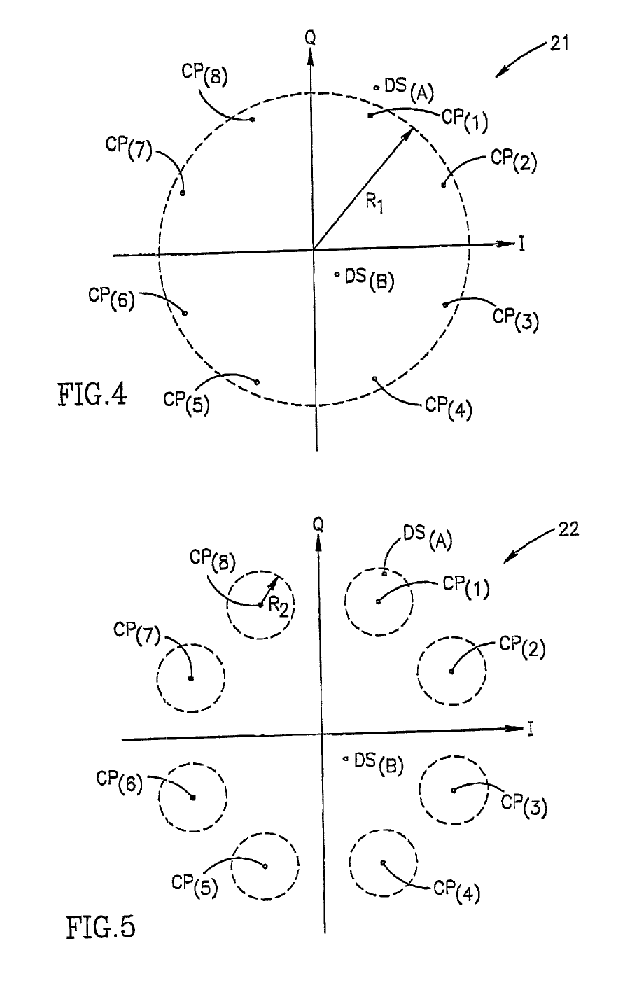

FIG. 3 shows the method for identifying a corrupt wireless data symbol DS as implemented by the nullification unit 16 for facilitating the decoding by the concatenation decoder 17, and in particular the ⅔ TCM decoder 18. Different error free power zones can be determined for the same mPSK or mQAM I signal constellation depending on inter alia the dimension of a selected m-dimension I/Q signal constellation, a desired E_{b}/Nₒ value, and others. A first exemplary error free power zone 21 (see FIG. 4) defined by a circular power threshold R₁ would entail that the nullification unit 16 nullify a data symbol DS on the condition that its I/Q values DS_{I} and DS_{Q} satisfy the condition: \sqrt{DS₁²+DS_{Q}²}>R. A second exemplary error free power zone 22 (see FIG. 5) defined by a circular power threshold R₂ in respect of each of the constellation points CP(1), CP(2), . . . CP(8) of an 8 I/Q signal constellation would entail that the nullification unit 16 nullify a data symbol on the condition that its I/Q values DS_{I} and DS_{Q} satisfy the condition: \sqrt{(DS₁−CP₁)²+(DS_{Q}−CP_{Q})²}>R where CP_{I} and CP_{Q} are the I/Q power values of each constellation point CP. In the present instances, the nullification unit 16 would nullify the data symbol DS(A) but not the data symbol DS(B) in the case of the power zone 21, and vice versa in the case of the power zone 22.

While the invention has been described with respect to a limited number of embodiments, it will be appreciated that many variations, modifications, and other applications of the invention can be made within the scope of the appended claims. For example, the maximum overall one-way transmission delay should be understood within the context of the present invention, namely, the use of concatenation FEC coding for toll quality voice traffic. Bearing this in mind, the upper limits of the transmit and receive delays D_{T} and D_{R} should preferably be as short as possible with a worst case in the vicinity of 5 ms, and preferably even shorter than 5 ms by, say, 5%. Both the outer and inner encoders/decoders can implement other schemes as follows: BCH, Block Turbo Code (BTC), amongst others for the former, and convolution, Convolutional Turbo Code (CTC), amongst others for the latter. The invention can be equally applied to modulations other than multi-code CDMA.

1. A bi-directional wireless telecommunication system comprising a pair of transceivers each including a transmitter having a transmit delay D_{T}, and a receiver having a receive delay D_{R};
characterized in that:
the telecommunication system implements compacted concatenated FEC coding, and has an overall one-way transmission delay including a transmit delay D_{T} and a receive delay D_{R} of less than about 10 ms.

2. The system according to claim 1 wherein the compacted concatenated FEC coding includes an outer RS scheme.

3. The system according to claim 1 wherein the compacted concatenated FEC coding includes an inner TCM scheme.

4. The system according to any one of claim s 1 to 3 wherein a transmitter comprises:
(One) a concatenation encoder including:
a) a data accumulation unit for accumulating data blocks from a stream of raw data;
b) an outer encoder for encoding the data blocks to provide a stream of encoded data symbols;
c) an inner encoder for encoding the stream of encoded data symbols to provide a stream of concatenated encoded data symbols;
(Two) a mapping unit for modulating the stream of concatenated encoded data symbols onto an m-dimension I/Q signal constellation where m=2^{k} and k=1, 2, . . . , n to provide a stream of modulated data symbols; and
(Three) a transmission unit for transmitting the stream of modulated data symbols;
characterized in that
the inner encoder directly encodes the stream of encoded data symbols from the outer encoder, and the transmitter has a maximum transmit delay D_{T} of less than about 5 ms.

5. The system according to claim 4 wherein the data accumulation unit accumulates data blocks at an approximate rate of one data block per 1.5 ms.

6. The system according to claim 5 wherein the data accumulation unit accumulates data blocks of less than 200 bits.

7. The system according to any one of claims 4 to 6 wherein the outer encoder implements an RS scheme and the inner encoder implements as TCM with scheme.

8. The system according to any one of claims 1 to 7 wherein a receiver comprises:
(One) a synchronization unit for reconstructing the I/Q signal constellation of an incoming modulated data symbol mapped onto an m-dimension I/Q signal constellation where m=2^{k} and k=1, 2, . . . , n to provide a stream of concatenated encoded data symbols; and
(Two) a concatenation decoder including:
a) an inner decoder for decoding the stream of concatenated encoded data symbols to provide a stream of encoded data symbols;
b) an outer decoder for decoding the stream of encoded data symbols to provide a stream of data;
characterized in that
the outer decoder directly decodes the stream of encoded data symbols from the inner decoder, and the receiver has a maximum receive delay D_{R} of less than about 5 ms.

9. The system according to claim 8 wherein the outer decoder implements an RS scheme and the inner decoder implements an TCM with SOVA scheme.

10. The system according to either claim 8 or 9 and further comprising a nullification unit for selectively nullifying concatenated encoded data symbols whose receiving power falls outside an error free power zone defined for the I/Q signal constellation.

11. The system according to claim 10 wherein said nullification unit selectively nullifies data symbols having I/Q power values DS_{I} and DS_{Q} such that \sqrt{DS₁²+DS_{Q}²}>R where R is the power threshold of the error free power zone.

12. The system according to claim 10 wherein said nullification unit selectively nullifies data symbols having I/Q power values DS_{I} and DS_{Q}
\sqrt{(DS₁−CP₁)²+(DS_{Q}−CP_{Q})²}>R
such that:
for each constellation point CPⱼ for j=1, 2, . . . , m where a constellation point CPⱼ has I/Q power values CP_{I} and CP_{Q}, and R is the power threshold of the error free power zone.

13. A transmitter according to any one of claims 4 to 7.

14. A receiver according to any one of claims 8 to 12.

15. A method for identifying a corrupt wireless data symbol, the method comprising the steps of:
(One) determining an error free power zone for an m-dimension I/Q signal constellation where m=2^{k} and k=1, 2, . . . , n;
(Two) reconstructing the I/Q signal constellation of an incoming modulated data symbol; and
(Three) identifying a data symbol as corrupt in the event that its receiving power falls outside the power zone.

16. The method according to claim 15 further comprising the step of:
(Four) nullifying a corrupt data symbol.

17. The method according to either claim 15 or 16 wherein a corrupt data symbol has I/Q power values DS_{I} and DS_{Q} such that \sqrt{DS₁²+DS_{Q}²}>R where R is the power threshold of the error free power zone.

18. The method according to claim 15 or 16 wherein a corrupt data symbol has I/Q power values DS_{I} and DS_{Q} such that:
\sqrt{(DS₁−CP₁)²+(DS_{Q}−CP_{Q})²}>R
for each constellation point CPⱼ for j=1, 2, . . . , m where a constellation point CPⱼ has I/Q power values CP_{I} and CP_{Q} and R is the power threshold of the error free power zone.
